(19) United States
(12) Patent Application Publication
(10) Pub. No.: US 2009/0063317 A1
(43) Pub. Date: Mar. 5, 2009

(54) COMPARING A LOCATION DERIVED FROM A PHYSICAL LOCATION TO A LOCATION ASSOCIATED THEREWITH BY A FINANCIAL SYSTEM

(75) Inventors: UMESH APTE, San Ramon, CA (US); Jason Aron Alonzo, Fair Oaks, CA (US); John Leong Yee, San Mateo, CA (US)

Correspondence Address: HICKMAN PALERMO TRUONG & BECKER/ORACLE, 2055 GATEWAY PLACE, SUITE 550, SAN JOSE, CA, 95110-1083, US

(73) Assignee: ORACLE INTERNATIONAL CORPORATION, Redwood Shores, CA (US)

(21) Appl. No.: 11/848,140

(22) Filed: Aug. 30, 2007

(51) Int. Cl. G06Q 40/00

(52) U.S. Cl. 705/35

(57) ABSTRACT

Data that describes asset attributes is stored in an asset information repository. One of the attributes corresponds to assets' financial application defined location. A network device is detected that links the assets to a network. Device identifiers, through which the assets link with the network, are identified. The device identifiers are mapped to a physical location associated with the network device. The physical location is used to derive a financial location, which is compared to the financial location defined for the asset by a financial system. Mismatches may be identified and reconciled.

The present invention relates generally to information technology. More specifically, embodiments of the present invention relate to comparing a financial location derived from a physical location to a financial location associated therewith by a financial system.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

Information technology (IT), the processing of information by computers, has become nearly ubiquitous in modern enterprises. Computers of various types abound in enterprise operations and typically proliferate as an enterprise grows. These computers include of course those of a very familiar variety, such as the “desktop” “personal computer” (PC) and workstation, and the more portable laptop. Such computers are often used with various peripheral equipment such as monitors, printers, network access equipment, etc., which themselves may be computerized (e.g., with their own processors, memory, etc.).

Some mainframe computers are more or less stationary with respect to their physical location and others, handhelds and cell phones for example, are characterized by their portability. While perhaps not considered as readily portable as laptops, desktop PCs, workstations and many peripherals may yet be transportable with relative ease.

Moreover, many modern enterprises use a diverse array of other computerized equipment. For instance, laboratories and industrial plants feature computerized instrumentation and/or machinery. Hospitals and clinics use computerized equipment such as X-Ray machines and various imagers (e.g., computer assisted tomography or ‘CAT’).

Computers perform various processing tasks, which may be assigned by, and results reported to, another, such as a management related computer. Several computers may also share access to various peripherals. Further, the functionality and power of computing may be increased by sharing computational tasks and peripherals among one or more other computers. These features increase efficiency.

To achieve these features, computers may be networked, e.g., communicatively coupled and integrated. Significant numbers of computers may be networked with others over one or more networks including the Internet. Networking allows efficient integration of a number and variety of applications in and/or between enterprises.

Computers and related devices are thus valuable IT assets. The value associated with various IT assets may vary depending on their nature, functionality and quality, etc. However, their value is almost never trivial, and in some cases may be quite significant. IT assets may represent a substantial investment to an enterprise. Moreover, IT asset value may relate to reliability and on-line availability. It may thus be important for hardware to be maintained and software monitored and updated. Quite prudently, enterprises thus try to keep careful track of their IT assets, for instance, with financial applications.

For instance, workstations, desktop PCs and peripherals may be assigned to a certain office in an enterprise with multiple offices. Likewise, an X-Ray machine may be assigned to a particular hospital radiology ward. Similarly, asset instruments like gas chromatographs and spectrophotometers may be assigned to a certain laboratory. Financial locations defined by financial applications are assigned to these assets and stored in a database associated therewith.

Financial locations are also associated with physical locations. For example, 2^{nd} Floor Bldg D and 3^{rd} Floor Bldg D may be associated with the financial location Manufacturing and 4^{th} Floor Bldg D may be associated with the financial location Customer Services. The financial location of an IT asset may be required to correspond to the financial location of the physical location at which the IT asset is located.

A financial application is input this information that associates the financial location with the asset. For example, a financial application may associate an IT asset with Manufacturing or with Customer Service.

As time passes however, the physical location of an IT asset may change, and hence the financial location of the IT asset may change. For example, the IT asset may be moved from 2^{nd} Floor Bldg D to 4^{th} Floor Bldg D. Further, the location change may be made on an ad hoc or individual basis, which may not be reported to the financial application. As a result, the financial location associated with the physical location of an IT asset may not correspond with financial location defined by a financial application.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts an example system, according to an embodiment of the present invention;

FIG. 2 depicts an example procedure, according to an embodiment of the present invention;

FIGS. 3A and 3B respectively depict an example display and user interface, according to an embodiment of the present invention; and

FIG. 4 depicts an example computer system platform, with which an embodiment of the present invention may be practiced.

### DESCRIPTION OF EXAMPLE EMBODIMENTS

Comparing the financial location derived from the physical location of an asset to a location associated therewith by a financial system is described herein. In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily obscuring the present invention.

### Overview

Example embodiments described herein relate to comparing a financial location of an asset recorded for the asset by a financial software application (“financial location of record”) to a financial location derived from a automatically detected physical location of the asset (“physically-derived financial location”). Information that is descriptive of one or more attributes associated with one or more assets (e.g., IT assets) is stored in an information repository, such as an asset database associated with the financial application. At least one of the attributes corresponds to a financial location of record, the financial location associated with the asset by a financial application.

A network device (e.g., a router or switch) is detected that links one or more of IT assets to a network. Identifiers associated with the network devices, such identities and port numbers through which the one or more IT assets link with (e.g., are communicatively coupled with, to, etc.) the network, are identified. One or more of the network device identifiers are mapped to a physical location. The physical location is used to determine a physically-derived financial location of the IT asset. The physically-derived financial location is compared to the financial location of record.

In an embodiment, mismatches may be identified between the physically-derived financial location and the financial location of record. The mismatch may be displayed to an administrator, or presented to the financial application in another way. A mechanism is provided in an embodiment for reconciling mismatches. A graphical user interface (GUI) or another mechanism may be provided to effectuate the reconciliation. The interface may be associated with the mismatch display. The GUI or other interface may allow the user to update the financial location of record to correspond to its physically-derived financial location.

According to an embodiment, the physically-derived financial location may be determined by use of a mapping that maps physical locations to financial locations defined by a financial application. Typically, multiple physical locations may be mapped to the same financial location e.g. 3^{rd} Floor Building E and 4^{th} Floor Building B can map to the same financial location.

### EXAMPLE SYSTEM

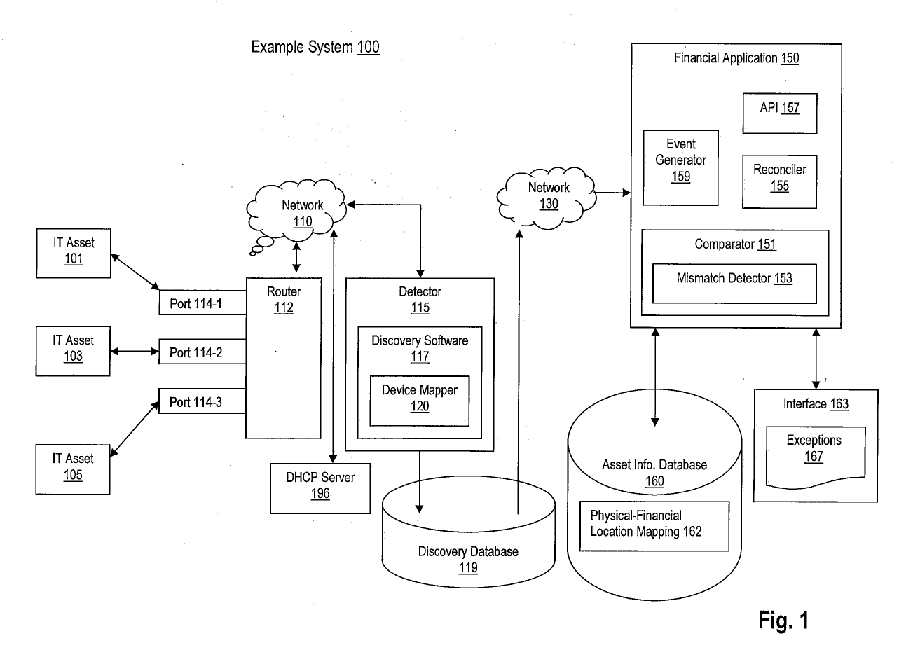

FIG. 1 depicts an example system 100, according to an embodiment of the present invention. System 100 functions to determine a physically-derived financial location of one or more enterprise IT assets and compare it to a financial location of record respectively associated therewith by a financial application. In an embodiment, one or more components of network 110, 130 comprise software executing in computer based hardware entities and thus, may be operably configured by one or more computer readable media, including storage media.

In an embodiment, one or more components of system 100 are linked (e.g., interconnected, communicatively coupled, etc.) via one or more networks. The networks may include one or more of a local area network (LAN), a wide area network (WAN), a public and/or private intranet and/or the Internet. In another embodiment, one or more components of system 100 are integrated, e.g., disposed within a single entity, with respect to one or more networks.

System 100 functions to allow the physically-derived financial locations of IT assets 101, 103 and 105 to be compared with financial locations of record respectively associated therewith by financial application 150. IT assets 101, 103 and 105 may comprise computers and/or computerized entities of virtually any kind, including, but not limited to, PCs, workstations, peripherals, instruments, machines or similar computerized equipment.

While the value associated with functionality of system 100 may be particularly notable to an enterprise for keeping track of readily portable assets, such as laptops, and with assets that may be transported with relative ease, such as desktop entities, its functionality is not limited thereto. Thus, system 100 may keep track of networkable IT assets that have virtually any transportability attribute.

The three example IT assets 101, 103 and 105 are depicted in FIG. 1, coupled within system 100 through a port 114-1, 114-2 or 114-3 on a single router 112, for simplicity and brevity in describing the example system. However, system 100 may keep track of virtually any networkable computerized entities, which may be coupled within the system through one or more ports on one or more network devices, which in addition to routers, may comprise network switches, gateways and other network devices.

Router 112 is assumed by financial application 150 to occupy a known, relatively fixed physical location. Computers may link (e.g., communicatively couple) with network 110 using one or more ports thereof. As depicted in FIG. 1, IT assets 101, 103 and 105 link with network 110 over ports 114-1, 114-2 and 114-3 of router 112. Ports 114-1, 114-2 and 114-3, each has a distinct IP address, among other identifiable characteristics. Network 110 may comprise a LAN. Network 110 may be associated with a dynamic host configuration (DHCP) server 196, which assigns a unique IP address for network 110 to each of IT assets 101, 103 and 105. However, system 100 is well suited to function in an embodiment without necessarily referencing the IP addresses thus assigned to IT assets 101, 103 and 105.

An IT asset such as a computer may have any number of physically discernable attributes, which may be used by an enterprise for cataloguing and tracking the assets. For example, a desktop PC may have corresponding characteristics such as a serial number, a make and model, a primary user and an assigned, e.g., financially defined location. Thus a certain PC asset of an enterprise may have attributes that include:
Serial No. 61RC5B1;
Manufacturer: Dell Computers, Inc.;
Model: “Latitude” D620;
Primary User: John Doe; and
Financial Location: Pleasonton HQ.
(of record)
   Information corresponding to these attributes may be stored in a repository such as a database associated by a financial application.

The financial application may be used by the enterprise to track the IT assets and other assets, using the stored information. While data associated with the make/model and serial number are stable, e.g., not expected to change over the life and/or the enterprise's possession of the asset (unless the asset is replaced due to damage, obsolescence, or maximized depreciation), other asset attributes may change. For instance, unless the asset accompanies him, if the primary user is transferred, dismissed, or promoted, then the ‘Primary User’ information corresponding to “John Doe” becomes stale.

Moreover, if the IT asset accompanies John Doe upon transfer or promotion that entails a move from an old physical location to a new physical location, the IT asset follows John Doe to the new physical location. The old and new physical position may be associated with different financial locations and the financial application should reflect his change.

DHCP server 196 may assign the IP address ‘10.123.156.187’ to IT asset 101. The IP address ‘10.123.156.187’ belongs to a finite range of IP addresses assigned by DHCP server 196 to router 112, which may correspond to a router with an identity ‘PLE-3RTE1’ that is known (e.g., as stored in one or more of databases 119 and 160) to be statically located at a certain locale, such as the “3rd Floor Building ‘E’, Pleasanton, Calif. Office Site” of an enterprise.

IP addresses may be public or private. Public IP addresses are generally associated with an enterprise by entities external thereto. An enterprise may have a finite number of public IP addresses associated therewith. In contrast, private IP addresses may be unique to networks internal (or otherwise non-public) to an enterprise. Network devices such as router 112 use Private IP addresses to identify computers such as IT assets 101, 103 and 105 linked thereto.

Private IP addressing schemes may use identical or overlapping IP address ranges at multiple sites, e.g., locations of an enterprise that are geographically distinct. Thus, an enterprise with office sites in Pleasanton, Calif., Singapore, and Denver, Colo., may respectively assign a range of IP addresses ‘10.123.156.1-10.123.156.255’ to each of these disparate sites. Thus, it is possible that an IT asset physically located at the Pleasanton, Calif. site has an identical IP address as an asset that is physically located at the Singapore site or at the Denver, Colo. site. An enterprise's network administrator may avoid such cross-assignments of the same IP addresses to more than one of the enterprise's sites, but the administrator's efforts may be tedious, laborious, time consuming, expensive and inefficient. However, an embodiment of the present invention avoids these issues.

For instance, in an embodiment one or more components, features and/or functions of system 100 maps identity information of router 112 and port numbers 114-1, 114-2 and 114-3 to a certain physical location. In an embodiment, IT assets 101, 103 and 105 are mapped to the same location as router 112, based on identifying the port number or other identity information associated with ports 114-1, 114-2 and 114-3 through which they couple to router 112. Thus, system 100 obviates IP address mapping to track IT assets 101, 103 and 105. Thus, an embodiment allows an enterprise to track IT assets 101, 103 and 105 without needing to map their locations based on the IP addresses assigned thereto by DHCP server 196.

An embodiment of the present invention thus provides a mapping scheme in which the network device and certain ports thereof are associated with (e.g., mapped to) a physical location. For example, router 112 may correspond to a router located at one of the example Pleasanton, Calif., Singapore, or Denver, Colo. office sites of the enterprise, described above. The mapping scheme provided by an embodiment may, for example, uniquely map the locations of network devices associated with the example enterprise office sites as follows:
Router PLE-3RT1 Ports No. 01-16<=>3rd Floor, Building E, Pleasanton, Calif. Office site;
Router PLE-3RT1 Ports No. 17-32<=>4th Floor, Building E, Pleasanton, Calif. Office site; and
Router SIN-1RT9 Ports No. 01-08<=>2nd Floor, 300 Orchard Rd., Singapore Office site

A detector 115 is linked to network 110. Detector 115 is linked to one or more networks including network 110. In an embodiment, a computer platform hosting detector 115 may be associated with router 112 or another device of network 110 or another network. Detector 115 detects (e.g., discovers, determines, ascertains, etc.) identities and other characteristics associated with entities such as IT assets 101, 103 and 105 that link to system 100 through one or more networks, including network 110. Detector 115 also reports the identity and other characteristics of network devices such as router 112 through which the entities link to the networks.

Discovery software 117 is operable with detector 115 and functions to allow the port number and other characteristics of ports 114-1, 114-2 and 114-3; and router 112 to be detected and, e.g., logged in database 119. Discovery software 117 also identifies entities, such as IT assets 101, 103 and 105, that link to network 110 via the network devices.

Discovery software 117 may perform this function by periodically scanning network 110 to discover devices that are linked thereto. Alternatively or in addition, network devices associated with network 110 such as router 112 may report to detector 115 upon an entity such as one or more of assets 101, 103 and 105 connecting to network 110 via the network device. Detector 115 may then correspondingly notify discovery software 117.

A device mapping functionality (e.g., mapper) 120 is operable with discovery software 117. Mapper 120 functions to map identities and other characteristics, including entities linking to networks therewith, of network devices to a physical location associated therewith. Mapper 120 stores this information, e.g., in a database or other repository.

Mapper 120 thus maps identities and other characteristics, including a port number for port 114, associated with router 112, to a physical location associated with router 112. Mapped characteristics also include identities and other characteristics of entities linked to network 110 via router 112, including identities associated with IT assets 101, 103 and 105 linked via ports 114-1, 114-2 and 114-3.

Database (or another repository) 119 is associated with detector 115. Database 119 stores information that relates to physical locations associated with each of the routers, switches and other network devices through which entities link to networks. Thus, database 119 stores information that relates to a physical location associated with router 112, including identity and other attributes of IT assets 101, 103 and 105, which link to network 110 via ports 114-1, 114-2 and 114-3 thereof. In an embodiment, database 119 is linked to a financial application 150 via network 130.

In an embodiment, financial application 150 is operable on a host computer platform linked to one or more networks including network 130. In another embodiment, financial application 150 is operable on a host computer platform that is associated with, or which also hosts detector 115. Financial application 150 is associated with an asset information database (or another repository) 160.

Asset information database 160 stores information relating to the assets of an enterprise, including IT assets 101, 103 and 105. The information stored in database 160 also includes physical-financial location mapping 162 that maps a physical location to financial location.

Financial application 150 has a comparator 151, which may include one or more software modules. For a particular asset, comparator 151 determines the physical location to which the asset has been mapped by mapper 120, determines the physically-derived financial location mapped to the physical location by physical-financial location mapping 162, and compares the physically-derived financial mapping to the financial location of record stored in database 160.

A situation may arise in which the financial location of record for one or more of IT assets 101, 103 and 105 stored in database 160 does not match the physically-derived financial location automatically determined by comparator 151. This mismatch between an IT asset's financial location of record and a physically-derived financial location may be detected by a mismatch detection component (e.g., mismatch detector) 153 of financial application 150. In an embodiment, mismatch detector 153 is a component of comparator 151. In another embodiment, mismatch detector 153 comprises a module or other component of financial application 150 that is distinct from, yet co-functional with comparator 151.

Upon detecting such a mismatch, an event generator module 159 of financial application 150 generates a list 167 of exceptions, which may be displayed with a user interface 163 to an administrator or other user. The list of exceptions 167 may include an alert, alarm or similar feature, to attract attention from the administrator.

Financial application 150 has a reconciliation mechanism (e.g., reconciler, reconciliator) 155. Reconciler module 155 functions to allow reconciliation of the mismatch detected between the physically-derived financial location and financial location of record of IT assets. The reconciliation mechanism is operable for reconciling, in database 160, physically-derived financial location and financial location of record of IT assets, to reflect the IT assets' true financial location.

In an embodiment, reconciliator 155 is triggered automatically upon event generator 159 generating exceptions list 167. In another embodiment, reconciliator 155 is triggered automatically upon mismatch detector 153 detecting the mismatch. In yet another embodiment, triggering reconciliator 155 may comprise a non-zero output of a logical ‘OR’ function that results upon either an input of mismatch detector 153 detecting the mismatch or event generator 159 generating exceptions list 167.

Thus, system 100 allows the financial locations of record for IT assets to be updated, refreshed, corrected, etc. in database 160. Moreover, the reconciliation may include an administrator initiating one or more of investigative or corrective action to restore an IT asset to a financial location desired by an enterprise, which may be reflected in the original (e.g., pre-reconciliation) financial application defined locations. This can promote recovery of IT assets that financial application 150 effectively lost track of, including misplaced or perhaps even stolen IT assets.

One or more of reconciler 155 and event generator 159 may function with user interface 163 using an application program interface (API) 157 component associated with financial application 150. In an embodiment for instance, interface 163 comprises a user-interactive interface such as a GUI that is co-hosted with financial application 150, a computer operable with, or which also hosts financial application 150. In another embodiment, interface 163 is alternatively hosted by a client computer that may be used by the administrator, and financial application 150 hosted on a server operably networked therewith.

An embodiment of the present invention may be practiced in which one or more functions of one or more components or features of example system 100, e.g., financial application 150 and/or device mapper 120 (and one or more repositories, e.g., database 160) are implemented using one or more versions of commercially available software. For instance, an embodiment may be practiced in which one or more functions of one or more components or features of system 100 are implemented using an existing or upcoming release (e.g., version) of PeopleSoft™ Information Technology Asset Management (ITAM) Product™ Release (e.g., a version following Releases 8.9 and Release 9). These product releases will be available commercially from one or more entities of Oracle,™ a corporation in Redwood Shores, Calif.

### EXAMPLE PROCEDURE

Procedures that may be implemented with an embodiment may be performed with more or less steps than the example steps shown and/or with steps executing in an order that may differ from that of the example procedures. The example procedures may execute on one or more computer systems under the control of machine readable instructions encoded in one or more computer readable storage media. The example procedures described herein may be performed in relation to comparing the physical location of an asset to a location associated therewith by a financial system.

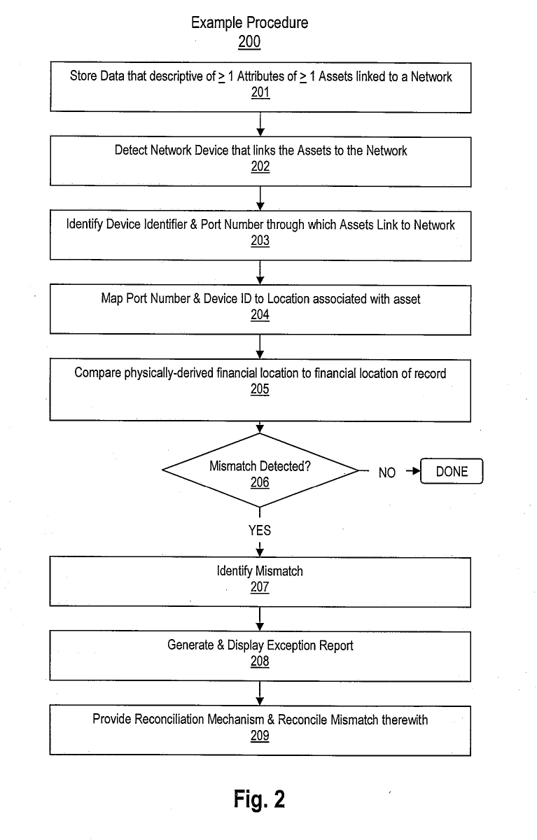

FIG. 2 depicts an example computer-implemented procedure 200, according to an embodiment of the present invention. In an embodiment, procedure 200 may execute on one or more computers associated with example system 100, described above with reference to FIG. 1. In an embodiment, procedure 200 may execute on one or more computers associated with the functions, operations etc. of a financial application (e.g., financial application 150).

In block 201, data that is descriptive of one or more attributes of one or more IT assets linked to a network is stored in a repository such as a database. In block 202, a network device such as a router or switch is detected, via which one or more of the IT assets are linked to the network. In block 203, an identifier (and optionally, one or more characteristics) of the network device are identified, including a port number thereof, via which one or more of the IT assets link to the network.

In block 204, the port number and device identifier are mapped to a physical location associated with an asset. In block 205, the financial location of an asset, derived from physical-financial location mapping 162, is compared to the financial location of record. In block 206, it is determined whether there is mismatch between the physically-derived financial location and the financial location of record in database 160. If not, procedure 200 may be complete.

In block 207, upon detecting a mismatch, the mismatch is identified (e.g., characterized). In block 208, a report of exceptions is generated and displayed based on and descriptive of the identified mismatch. In block 209, a mechanism to reconcile the mismatch is provided and an administrator may use the mechanism to reconcile the mismatch.

### EXAMPLE EXCEPTION REPORT & RECONCILIATION MECHANISM

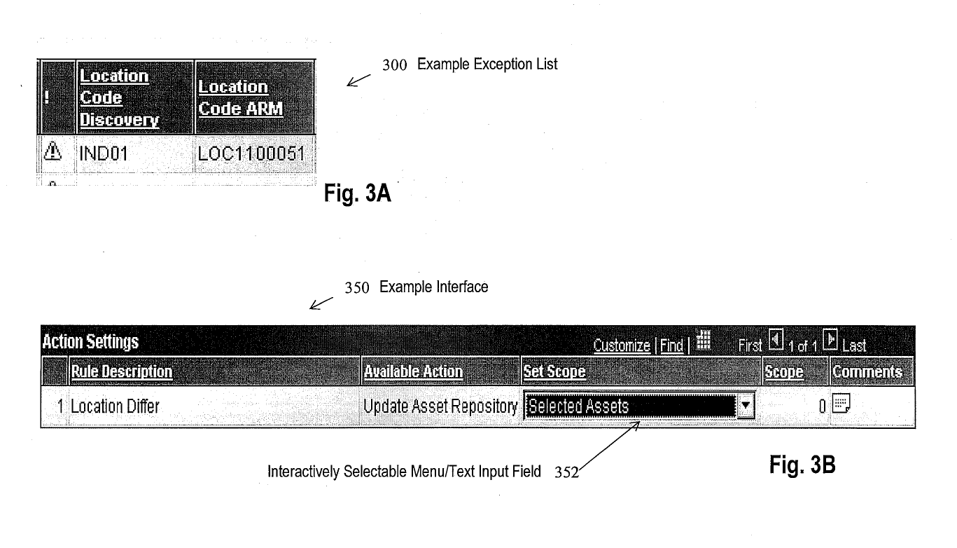

FIGS. 3A and 3B respectively depict an example display 300 and a user interface 350, according to an embodiment of the present invention. Display 300 provides a report of exceptions generated that describe a mismatch that is identified between the financial location mapped from the physical location and the financial application defined location for the IT asset, e.g., according to procedure 200. User interface 350 is depicted as an example GUI. GUI 350 has an interactively selectable dropdown menu 352.

Menu 352 allows an administrator to reconcile a mismatch between the physically-derived financial location and the financial location of record for the IT asset. For example, the administrator may select an entry from menu 352 (or e.g., enter text in a selectable text field) to update asset information database 160 with the automatically determined physically-derived financial location of one or more of IT assets 101, 103, and 105. The administrator may also initiate investigative and/or corrective action to reposition the IT asset to a more desirable location (e.g., the financial application defined location originally associated therewith). In an embodiment, the reconciliation action may be automated by one or more system components or features.

### EXAMPLE COMPUTER SYSTEM PLATFORM

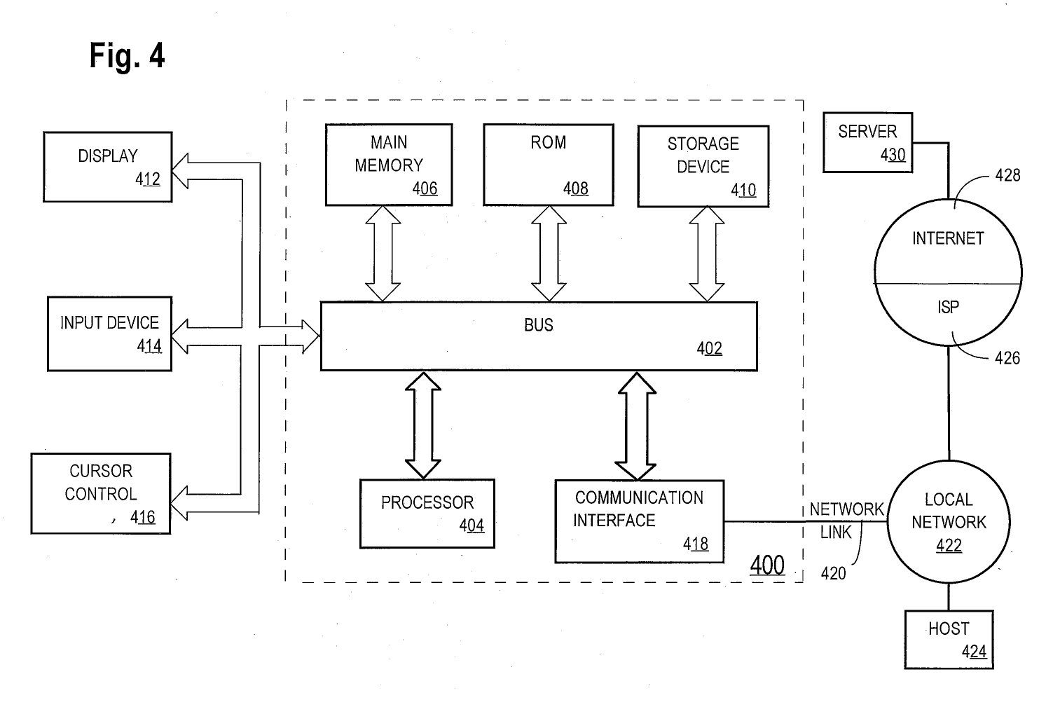

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a liquid crystal display (LCD) cathode ray tube (CRT) or the like, for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for comparing the physical location of an asset to a location associated therewith by a financial system. According to one embodiment of the invention, comparing the physical location of an asset to a location associated therewith by a financial system is provided by computer system 400 in response to processor 404 executing one or more sequences of one or more instructions contained in main memory 406. Such instructions may be read into main memory 406 from another computer-readable medium, such as storage device 410. Execution of the sequences of instructions contained in main memory 406 causes processor 404 to perform the process steps described herein. One or more processors in a multi-processing arrangement may also be employed to execute the sequences of instructions contained in main memory 406. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other legacy or other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem (modulator/demodulator). A modem local to computer system 400 can receive the data on the telephone line and use an infrared transmitter to convert the data to an infrared signal. An infrared detector coupled to bus 402 can receive the data carried in the infrared signal and place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a digital subscriber link (DSL), cable or other modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418. In accordance with the invention, one such downloaded application provides for comparing the physical location of an asset to a location associated therewith by a financial system as described herein.

The received code may be executed by processor 404 as it is received, and/or stored in storage device 410, or other non-volatile storage for later execution. In this manner, computer system 400 may obtain application code in the form of a carrier wave.

### EQUIVALENTS, EXTENSIONS, ALTERNATIVES AND MISCELLANEOUS

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method, comprising:
determining a physical location of an asset based on a network device to which the asset is physically connected;
storing a financial location of record in association with the asset, said financial location being among financial locations defined by a database;
storing a mapping between physical locations and the financial locations;
based on the physical location and the mapping, determining a mapped financial location; and
making a determining of whether said financial location of record matches said mapped financial location.

2. The computer-implemented method of claim 1, wherein:
the network device comprises a plurality of ports;
the asset is coupled to a first port of said plurality of ports; and
determining a physical location of an asset includes determining that a mapping maps the first port of said plurality of ports to said physical location.

3. The computer-implemented method of claim 1, wherein determining a mapped financial location includes determining that a mapping maps the physical location to the mapped financial location.

4. A method, comprising:
storing data that describes one or more attributes of one or more devices, which are communicatively couplable with a network, in a repository wherein at least one of the one or more attributes corresponds to a financial system location defined by a financial system that stores information associated with each of the one or more devices;
detecting a router or switch, which communicatively couples one or more devices to the network;
upon detecting the router or switch, identifying an identity and port numbers, through which the one or more devices are communicatively coupled with the network, of the router or switch;
mapping at least one of the identity and the port numbers of the router or switch to a physical location associated with the router or switch; and
mapping the physical location associated with the router or switch to a mapped financial location; and
comparing the mapped financial location to a financial system defined location associated with a device of one or more devices.

5. The method as recited in claim 4, further comprising:
upon comparing the mapped financial location to the financial system defined location, detecting a mismatch between the mapped financial location and the financial system defined location; and
upon detecting the mismatch, identifying the mismatch.

6. The method as recited in claim 5, further comprising upon recording the mismatch, providing a mechanism with which the mismatch may be reconciled.

7. The method as recited in claim 6, further comprising reconciling the mismatch, wherein reconciling the mismatch includes changing the financial system defined location to reflect the mapped financial location.

8. The method as recited in claim 5 wherein identifying the mismatch comprises:
generating an exception; and
displaying a report relating to the exception.

9. A computer-readable medium carrying one or more sequences of instructions which, when executed by one or more processors, causes the one or more processors to perform the method recited in claim 1.

10. A computer-readable medium carrying one or more sequences of instructions which, when executed by one or more processors, causes the one or more processors to perform the method recited in claim 2.

11. A computer-readable medium carrying one or more sequences of instructions which, when executed by one or more processors, causes the one or more processors to perform the method recited in claim 3.

12. A computer-readable medium carrying one or more sequences of instructions which, when executed by one or more processors, causes the one or more processors to perform the method recited in claim 4.

13. A computer-readable medium carrying one or more sequences of instructions which, when executed by one or more processors, causes the one or more processors to perform the method recited in claim 5.

14. A computer-readable medium carrying one or more sequences of instructions which, when executed by one or more processors, causes the one or more processors to perform the method recited in claim 6.

15. A computer-readable medium carrying one or more sequences of instructions which, when executed by one or more processors, causes the one or more processors to perform the method recited in claim 7.

16. A computer-readable medium carrying one or more sequences of instructions which, when executed by one or more processors, causes the one or more processors to perform the method recited in claim 8.
